(19) United States
(12) Patent Application Publication
(10) Pub. No.: US 2021/0016897 A1
(43) Pub. Date: Jan. 21, 2021

(54) SYSTEM FOR AIR AND GROUND TRANSPORTATION

(71) Applicant: Mannvirki og malbik ehf., Reykjanesbaer (IS)

(72) Inventor: Sigurdur KRISTOFERSSON, Reykjanesbaer (IS)

(21) Appl. No.: 16/981,212

(22) PCT Filed: Mar. 15, 2019
(86) PCT No.: PCT/IS2019/050003

§ 371 Date: Sep. 15, 2020

(30) Foreign Application Priority Data
Mar. 16, 2018 (IS) IS 050215

(51) Int. Cl. B64F 1/00; E01F 9/512

(52) U.S. Cl. CPC B64F 1/002; E01F 9/512

(57) ABSTRACT

Disclosed is a system for horizontal marking of air and ground transportation. The system comprises at least one sheet of a pliant mesh material that is preferably at least 30% open when in use and preferably has a ground footprint weight of at least 0.4 kg/m². The marking system is adapted to be disposed on an horizontal surface in a generally horizontal fashion, so as to provide a sign for conveying information to air and/or ground traffic. Also disclosed is a method of directing air or ground traffic using such a horizontal marking system.

### INTRODUCTION

Airport markings and signs serve the role of providing information to airplane pilots during takeoff, landing and taxiing. The uniformity of markings is important to enhance both safety and efficiency. For these reasons, airport markings are highly regulated, including both permanent and temporary markings. For example, in the United States, the Federal Aviation Authority (FAA) has issued an Advisory for such markings (https://www.faa.gov/documentLibrary/media/Advisory_Circular/150_5340_11 pdf). According to this advisory, runways that are closed should be marked with a lighted, raised “X” or by an “X” that is placed over the runway designation marking or just off the runway. The “X” must be yellow in color, and should provide a solid appearance and not flap in wind, such as by use of ground anchor device.

Similar provisions are provided for in Europe, as issued by the European Aviation Safety (https://www.easa.europa.eu/sites/default/files/dfu/2014-013-R-Annex%20to%20ED%20Decision%202014-013-R.pdf). Here, a closed marking should be placed at end of runway. The marking should be white when placed on runway and yellow when placed on taxiway. On runways, the marking should have an “X” shape, with dimensions of 14.5 m×36 m, and each arm in the “X” should be 1.8 m wide. On taxiways, the “X” shape is different (arms at 90° angle) with each arm being 9 m×1.5 m. It is recommended that closure markings be placed at no more than 300 m intervals along a runway to be marked as closed, which means that 10 such markings are to be placed on a 3 km long runway.

A variety of methods have been used or proposed to mark runways. One solution involves painting a marker over existing marks on the runway or taxiway (usually a number or code identifying the runway/taxiway). This method has obvious drawbacks: Applying the marking takes significant time and effort, since it involves physically painting a very large marking on the ground surface. The removal is even more labor intensive, since the marking must the removed by washing or using chemical and/or physical treatment to remove the marking.

Physical markings have therefore been proposed. Such markings have however the disadvantage of being difficult to move, when made from heavy and/or rigid material, or being unstable to weather conditions, in particular wind, when made from lightweight material.

Markings for runways and taxiways are often painted directly on the paving and then they need to be scraped off. This is both costly and the paint cannot be considered environmentally friendly as it is either removed with machines or washed off with high-pressure, which blows paint residue into the environment. The high-pressure washing can also damage the surface of runways and taxiways.

Therefore, marking systems that include means for securing the marking have been proposed.

For example, U.S. Pat. No. 7,302,908 B1 discloses an air and ground transportation marker that comprises first and second sheets of material that have perimeter edges with a fluid ballast bladder, for permitting fluid to be filling the bladder so as to stabilize the sheet of material when placed on the ground.

In US 2002/0104472 A1, a movable air and ground traffic marker is disclosed, the marker having one or more fastening means, such as grommets, that can be used to removable attach the marker to ground, to keep the marker in place.

These marking systems have however the drawback of being cumbersome to use, due to the need for additional securing means to keep the markings in place.

There is a need for a marking system for providing air and ground traffic marking in airports that can easily be adapted to varying regulations and that can easily be applied and removed without use of securing and/or fastening means.

### SUMMARY

The present invention relates to a system for air and ground transport marking, in particular in airports. The system has several advantages, including being self-contained, pliable and stable to extreme weather conditions, in particular high winds. In an aspect, the invention provides a system for horizontal marking of air and ground transportation, the system comprising at least one sheet of a pliant material, the sheet comprising a mesh material that, when in use, is at least 30% open, and wherein the at least one sheet is adapted to be disposed on an horizontal surface in a generally horizontal fashion, so as to provide a sign for conveying information to air and/or ground traffic.

Preferably, the at least one sheet has a ground footprint weight of at least 0.4 kg/m², i.e. the material that is required to cover one square meter of ground surface weight at least 0.4 kg. The at least one sheet can be considered to be in use once placed on ground so as to form a marking for air and/or ground transport. During such use, the at least one sheet is preferably in an extended form, i.e. the at least one sheet is not folded or otherwise condensed.

The invention also relates to methods of directing air and/or ground traffic within airports. Thus, in an aspect the invention provides a method of directing air or ground traffic, the method comprising steps of (1) providing at least one sheet of a pliant material, the sheet comprising a mesh material that is at least 30% open and, and (2) positioning the at least one sheet on an horizontal surface in a generally horizontal fashion, so that the at least one sheet as positioned provides a sign for conveying information to air and/or ground traffic that can be detected from a distance, whereby air or ground traffic that approaches the sign is directed to adapt their direction of travel in response to the sign.

Preferably, the at least one sheet can have a ground footprint weight of at least 0.4 kg/m².

Another aspect of the invention relates to system for horizontal marking of air and ground transportation, the system comprising at least one sheet of a pliant material, the sheet comprising a netlike mesh material that comprises interweaved threads having openings therebetween with an average diameter of the openings in the range of 2 to 10 mm, wherein the material is at least 50% open, and wherein the at least one sheet is adapted to be disposed on an horizontal surface in a generally horizontal fashion, so as to provide a sign for conveying information to air and/or ground traffic. The material can, during use, have a ground footprint weight of at least 0.4 kg/m².

The system can be particularly useful for marking of aircraft runways and/or taxiways and ground transportation in airports or airfields. For example, the system can be useful for marking aircraft runways and/or aircraft taxiways in addition to ground transportation along roadways or taxiways within an airport. Aircraft taxiways can also include helicopter landing strips or helicopter landing pads.

In the present context, the term “mesh material” should be understood to mean a material that comprises barriers of connected strands or threads of solid flexible and/or ductile materials. The mesh material comprises a solid component, represented by the interconnected threads, and an open component, represented by openings in the material, between the threads. A representative mesh material is a net or net-like material. In the present context, the term “open” is to be understood as the percentage of ground that is visible through a material directly from above (i.e. from a vertical position) when the material is placed flat on the ground. For example, a solid piece of flat plywood material, when placed on the ground, covers the ground completely; as a consequence, the material is 0% open. By contrast, a fishing net, when placed onto ground, can allow about 70% or more of the ground to be visible through the net from a vertical position, meaning that the fishing net is, in this context, 70% open or more. In general, a mesh material can be anywhere from close to 0% open (i.e., when only very small or very few, or both, openings are in the material), to almost 100% open (when the material is made from very fine fibres or threads, with relatively few and large openings in the material).

The system and method can comprise at least one sheet of mesh material that, when in use (i.e. when extended on ground in a non-folded manner), is at least 30% open, at least 40% open, at least 50% open, at least 60% open, at least 70% open, or at least 80% open. In some embodiments, the at least one sheet of material can be in the range of 30% to 90% open, such as in the range of 30% to 90%, in the range of 40% to 90%, in the range of 50% to 90%, in the range of 60% to 90% or in the range of 60% to 80%.

In the present context, the term “ground footprint weight”, is meant to refer to the weight per square meter of the material, when in use on ground. For example, a mesh material can, when placed flat in an extended manner on the ground (i.e. not folded back on itself or rolled up), can have a weight of about 1 kg/m², i.e. the material that covers 1 m² of ground when in use weighs about 1 kg.

The ground footprint weight of the material in accordance with the invention can in general be at least 0.4 kg/m², at least 0.5 kg/m², at least 0.6 kg/m², at least 0.7 kg/m², at least 0.8 kg/m², at least 0.9 kg/m², at least 1.0 kg/m², at least 1.5 kg/m² or at least 2.0 kg/m².

The mesh material of the invention in general is a material that has sufficient ground footprint weight and sufficiently open so as to be stable to horizontal perturbations by wind. Thus the material can be stable to such perturbations when in use on a flat surface in high wind, for example wind in excess of 15 m/s, wind in excess of 20 m/s or wind in excess of 25 m/s.

Thus the sheets of mesh material preferably do not get blown away by wind, i.e. the sheets remain on ground in the locations where they have been placed, so as to convey the appropriate signalling even during conditions of high wind.

Preferably, the sheet material does not fold up at all once placed in a stretched configuration on ground. However, even if the edges of the material move intermittently during high winds, the sheet as a whole is stable to high winds and does not get blown away. This is a result of a combination of the sheet material being mesh-like, such that wind forces (lift and horizontal displacement) are not sufficient to move the material. In other words, due to the material being relatively open and having a uniform or near-uniform distribution of openings in its structure, wind is not able to provide enough force to lift and displace the material.

Consider for example the weight of the marking system: A sheet of meshlike material that has dimensions of 1.8 m×40 m (e.g., one of the two arms forming an X) would, for a ground footprint weight of 0.5 kg/m², weigh about 36 kg. A sheet of material having dimensions of 20×30 m would, for the same ground footprint weight, have an overall weight of about 300 kg. Thus, considerable forces would be required to move such sheets of material, and due to their structure, the sheets are stable to horizontal or near-horizontal wind. An added factor are drag forces, since, for horizontal movement along ground, the frictional forces between the material and ground would have to be overcome.

For this purpose, any combination of the above disclosed ranges of openness of the mesh material and ground footprint weight of the mesh material is contemplated.

The mesh material is preferably a pliant material that can easily be made compact for transport and/or storage, such as by folding, rolling up and the like. Thereby, the marking systems becomes easy to handle and can easily be transported between its locations of use, or between storage facilities and runways and/or taxiways. The marking system may also, or alternatively, be used on airport roadways.

Preferably, the ground footprint of sheets of the mesh material is significantly less during storage than during use. Preferably, the ground footprint during storage can be less than 10% than during use, more preferably less than 5%, more preferably less than 4%, more preferably less than 3%, even more preferably less than 2%, even more preferably less than 1%.

The sheets of mesh material can be removed from a storage location and transported to the site of marking, for example the end of a runway. There, the sheed can be unfolded and stretched onto the runway so as to provide the required marking. No further attachment to the ground is required, as the sheet is stable to weather conditions, in particular wind, once placed on ground.

Pliant mesh materials are known in the art. Exemplary materials are nets or net-like materials used in fences, fishing nets, sports facilities (e.g., goals and the like) and in windbreaking structures. The mesh material can alternatively be provided by any other woven or knitted material comprising interconnected threads that results in a material having a partially open structure.

As discussed in the above, a major limitation and disadvantage of most lightweight materials is that they are sensitive to wind. Thus, thin and/or open mesh materials are usually susceptible to being blown away by strong winds, which is unacceptable for their use as airport markings.

The inventors have however discovered that by careful selection of material that fulfills certain parameters, particular mesh materials can be used for runway and taxiway markings, and do not require additional fastening means. Thus, pliable mesh materials that have certain degree of openness and have certain minimal weight per square meter have been found to be useful as markings and can withstand high winds when placed flat on ground.

In principle, a material to be used as a marking can be made as heavy as possible so that it does not move even in strong winds. For example, a mesh material from metal wire or other heavy materials could be used. However, such markings would be too heavy to move, and also would not be pliable for folding up during storage.

A further advantage of the invention is that the mesh material is also environmentally friendly in the sense that it will not damage the runways and taxi ways or contaminate the environment, in contrast to the application of permanent markings that are painted onto the runway and must subsequently be removed, generating environmentally unfriendly waste products.

The inventors found that a particular combination of mesh material openness and material density is optimal so that the material does not move, even in strong winds, yet is relatively lightweight and pliable so that it can easily be made compact for transport and storage.

A mesh material that is too closed absorbs a high proportion of wind. As a consequence, at high winds, such material will not be strong enough to withstand wind, and the material will be blown from its position on ground so that the material at least partially is folded. Thereby, the structural integrity of the marking provided by the material will be lost, and the marking therefore useless.

Wind fences or wind banners that are known in the art represent such mesh materials that are relatively closed (opening much less than 50%).

By contrast, a mesh material that is very open and of high density will be able to withstand high winds when placed on ground, because the material is highly permeable to wind, i.e. wind passes relatively freely through the material. However, such material cannot provide the functional role of providing an appropriate sign to air traffic, because the material must appear to be solid, or have a solid appearance, when viewed from a distance, i.e. from a distance of tens of meters or more (for taxiway markings) or hundreds of meters or more (for runway markings).

The present inventors have found that there exist a fine balance between mesh openness and material density that is critical for the usefulness of the material as a marker that is able to withstand high wind, yet at the same time be pliable and relatively lightweight. This balance is achieved by using pliable mesh material as disclosed herein.

Mesh width, in the present context, should be understood as the distance between corners in a mesh, which can typically have four or more corners. For knotted nets, the mesh width can be measured from the middle of one knot to the middle of an oppositely positioned knot. Alternatively, mesh width can be measured by a so-called half mesh, which is the distance between adjacent knots in a mesh. For mesh structures having many corners and an overall non-symmetrical shape, the mesh width can be defined as the average width between corners or diagonally opposite sides in each mesh.

Thus, a mesh can comprise rectangular or elongate openings. When elongate, mesh width can represent the average distance between opposite corners in openings in the mesh. Mesh can also comprise generally round openings.

The mesh is preferably provided so that from a distance, the mesh material appears continuous, i.e. the openings or holes in the mesh are not visible as such to the human eye. This way, markings in the mesh, or markings provided by the mesh material itself (e.g., by coloring) appear solid and continuous from a distance.

The relative dimensions of the mesh material are very important for its usefulness in the marking system. Parameters that needed to be optimized were (i) density, (ii) mesh width, (iii) openness, so as to generate a marking system that is (a) highly pliant, so that it can be folded, rolled up or in other ways made compact for transport and/or storage, (b) uniformly open, so that the material can withstand high wind when provided in an extended form on the ground as a marking, (c) solid enough so that from a distance, marking provided in the mesh material, or marking provided by the mesh material appears continuous.

Many types of mesh material, for example those used in fences and the like, appear transparent from a distance, due to the relatively small diameter of the string or wire used in the material. Such material would not be workable as a marking system, since the marking would becomes increasingly faint with distance, in opposite to what is required for marking systems at airports.

The mesh material can include openings that are of uniform size and shape, or the material can comprise a variety of openings. Thus the openings can vary in size or in shape, or both. The openings can be of any particular shape, such as round, square, pentagonal, hexagonal, heptagonal or octagonal.

A mesh material in accordance with the invention can in general comprise a net-like structure that, on average, has an average mesh width that is in the range of about 5 to 100 mm, preferably in the range of about 10 to 80 mm, more preferably in the range of about 10 to 60 mm, more preferably in the range of about 10 to 50 mm, even more preferably in the range of about 15 to 35 mm. In this context, “average mesh width” should be understood as the average length of the distance between individual threads in the mesh, measured at the widest point of each open space or opening between the threads, in the context of a four-cornered mesh the wider distance between opposite corners in each open space in the mesh structure.

The mesh material can thus comprise a net or net-like structure of interweaved threads or threads. The threads in such material can have an average diameter that is in the range of about 2 mm to about 20 mm, preferably in the range of about 2 mm to about 15 mm, more preferably in the range of about 2 mm to about 10 mm, more preferably about 3 mm to about 8 mm, even more preferably about 4 mm to about 7 mm.

The mesh material can in general be woven, knitted, expanded, welded or produced by other means known in the art. When provided as a net or net-like material, the mesh material can be produced using any known method for generating nets, including but not limited to methods of making knotted nets.

When the mesh material is provided as an interweaved thread material, there will be a relationship between mesh width and the width of the threads in the material. Thus, the smaller the thread diameter, the smaller the average mesh width should be for optimal function of the resulting mesh material. For example, for a material with a thread width of 2 mm, the optimal mesh width will be smaller than for a material with a thread width of 6 mm. For the former (2 mm threads), the optimal mesh width can be in the range of 10-20 mm, while for the latter (6 mm threads), the optimal mesh width can be in the range of 30-40 mm. The resulting material will however have comparable characteristics in terms of openness and ground footprint weight.

The material used in the mesh material can be a suitable hydrophobic material, e.g. synthetic fibre, such as polyamide (Nylon, Perlon), polyester (Terylene, Dacron, Tetoron, Trevira), polyethylene (Nymplex, Courlene), polypropylene (Danaflex, Multiflex, Ulstron), aramid (Kevlar), high-density polyethylene (Dyneema, Spektra, Dynex). Nylon polymers can for example be one of Nylon 66, Nylon 6, Nylon 510, Nylon 1,6.

The mesh material can comprise a homogeneous material, or it can comprise a mixture of materials. For example, the mesh material can comprise a net or netlike material that comprises fibres or threads consisting of a single material. Alternatively, the mesh material can comprise a net or netlike material that comprises threads made from different materials. This can be useful, e.g. for producing a mesh material with optimized density, strength and/or pliability so as to be able to provide a marking system with optimal function.

The mesh material can be in the form of a knotted or knotless net that are known in the art. For example, knotless nets can be of a twisted type, a crochet type (also collared ultra cross net) or a braided type.

Knotted mesh materials, e.g. knotted nets, will as a result of the knotting have an irregular structure. Thus, single threads in the net structure meet in a knot, where usually three or more threads are knotted together. As a result, the resulting knot provides the material with an uneven size along each thread; thus, along each thread there will be a wider portion representing the meeting point (the knot) between threads in the structure.

The presence of knots usually results in an unevenness of the resulting material, in that when placed flat on the ground, individual threads will not all be parallel to ground, since the knots are wider than individual threads. Generally, this can lead to a “wavy” appearance of the material, such that individual openings in the material have different orientation with respect to ground.

As a result of such unevenness, the material, in particular when viewed from an angle, can have a more solid-like appearance than it would have if perfectly flat in structure. Thus, openings in the material that are at an angle will appear solid or close to solid when viewed at an angle that is close to the angle of the plane of the opening with respect to ground—i.e. the opening is viewed almost edge-on from the particular angle from which the material is viewed. This unevenness in the material can be advantageous for its use as a marking, since the material will have a more solid appearance from an angle than it would otherwise have.

When provided from rope, the net can have any suitable twisting of fibres or threads. The net can also comprise, or consist of, a combination of wire and rope, often referred to as combination ropes. Such combination ropes can consist of a combination of a steel wire and textile fibres, wherein the fibre can either be on the inside or the outside of the overall rope structure.

Nets or netlike mesh materials in general will allow wind to pass through openings in the material. Due to the relatively thin threads in materials, wind will however not be able to displace the material, since the accessible surface area available to incoming wind is small compared with surrounding openings in the material. As a consequence, there will be little “lift” in the material, in contrast to solid materials. For example, a solid piece of material, whether provided as a solid sheet of fiber material or provided as for example solid flat wooden or metal panels, will be highly susceptible to wind capturing and displacing the material since the solid nature of the material results in extensive wind lift. Forces from approaching wind (i) generate a reduced pressure over the material, due to the wind passing rapidly over the material, and (ii) generate lift from wind that is able to penetrate under the material when placed on ground. Combined, these two forces can be substantial, and able to lift and thereby displace even very heavy pieces of solid material (which can either be continuous, i.e. with no openings or holes in the material, or with holes that are relatively few and/or small, such that the material is mostly closed, its percentage of openness being small (e.g., less than 10%).

An advantage of knotted net as the mesh material used in the marking is that the net, when placed on ground, will not lie uniformly flat on the ground. Due to inherent irregularity in many knotted nets, there will be a natural undulation in the material, due to unevenness in the knots in the net. Due to this irregularity, the material will from a distance have a more “solid” appearance than if it were completely and uniformly flat on ground. This effect is in particular strong from an angle, which is the typical relevant view from an approaching aircraft or ground vehicle.

The marking system can comprise two or more components that, when connected appropriately onto ground, provide an appropriate air and/or ground traffic signal. For example, the system can comprise, or consist of, two sheets of rectangular material that are disposed on ground so as to form a sign having an X-shaped form. Additional sheets and/or sheets having other shapes or dimensions can be added, so as to generate any desired marking. When provided as two or more sheets of material, the sheets can be assembled to form the desired marking at the desired location. Alternatively, the sheets can be preassembled, for example by wearing or stitching the sheets together. Thereby, the sheets can be stored and transported as a single unit or piece, to produce the desired marking when stretched onto a runway or taxiway.

Alternatively, the system can comprise or consist of a single sheet of pliable mesh material that has a built-in marking or indicium. For example, the system can comprise a single rectangular sheet of mesh material that has an appropriate marking or indicium incorporated in the material. The indicium (for example X) can be incorporated in the material by using coloring in the material, or by weaving a thread having a distinct color in the material, or both.

An alternative use of the marking system is that of covering an existing marking on a runway or taxiway. Thus, a mesh material sheet of a uniform color, for example black or grey, can be placed on a runway or taxiway so as to cover an existing marking. From a distance, the sheet will appear like a continuous sheet of material that has approximately the same color as the underlying runway or taxiway, and thereby not providing as such any additional or new marking. This can be useful if, for whatever reason, it becomes essential to temporarily cover runway and/or taxiway markings.

Although not required for use in normal weather conditions, the markings in accordance with the inventions can be provided with additional reinforcements when in use during extreme conditions. For example, if in use in extreme winds, such as winds that are in the excess of 20 m/s, the markings can be stabilized by for example threading metal rods along at least a portion of the periphery of the markings. Such metal rods can for example be threaded into the material or threaded into sleeves that can be provided in the pliable mesh material, along its outer periphery.

An alternative manner in which the mesh material marking system can be made even less sensitive to wind is to increase the natural density of the material. This can for example be done by using mesh material having a relatively high density. For example, the mesh material can comprise a net structure, in which the threads in the net comprise material that has high density, for example by providing lead or lead-containing threads in the material that provide the material with increased density while at the same time retaining its pliable nature.

Yet another way in which the mesh material can be made heavier is to thread and/or weave a thread having a high density into the material. Such thread can be weaved at regular intervals in the material. The threads can also, or alternatively be threaded along the periphery of the mesh material sheet.

The above features along with additional details of the invention, are described further in the following description, which is intended to further illustrate the invention but is not intended to limit its scope in any way.

### BRIEF DESCRIPTION OF THE DRAWINGS

The skilled person will understand that the drawings, described below, are for illustration purposes only. The drawings are not intended to limit the scope of the present teachings in any way.

FIG. 1 shows a schematic view of a part of an airport marking, as well as a close-up view of a portion of the mesh material.

FIG. 2 shows another application, in which the marking system can be used to cover a runway marking.

FIG. 3 shows a marking system that comprises a square sheet of mesh material that has a marking incorporated to signal the closure of a runway.

FIG. 4 shows a marking system that comprises a square sheet of material that includes a marking for designating closure of a taxiway.

FIG. 5 shows a marking system, wherein two sheets of elongate rectangular material are placed on a runway so as to generate a signal (X) indicating closure of the runway.

FIG. 6 shows representative examples of a mesh-like net material and its use in the present invention.

FIG. 7 shows a view of an airport, indicating how markings on runways and taxiways can be used to provide signaling information.

### DESCRIPTION OF VARIOUS EMBODIMENTS

In the following, exemplary embodiments of the invention will be described, referring to the figures. These examples are provided to provide further understanding of the invention, without limiting its scope.

In the following description, a series of steps are described. The skilled person will appreciate that unless required by the context, the order of steps is not critical for the resulting configuration and its effect. Further, it will be apparent to the skilled person that irrespective of the order of steps, the presence or absence of time delay between steps, can be present between some or all of the described steps.

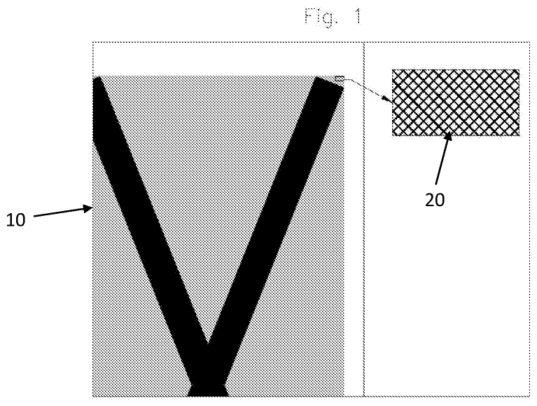

Turning to FIG. 1, there is shown a schematic view of a portion of an airport runway or taxiway marking system. The system contains a single sheet 10 of material that includes a marking forming an “X”. For illustrative purposes, the marking in the mesh material 20 is shown in black. In reality, current regulation require white or yellow markings, which can be shown in the same fashion. The insert in the figures shows that the material in the marking system is in fact a mesh material 20 that is relatively open (in the illustrated in excess of 50%). The relative openness of the material and its density leads to the desired properties of (i) being open to air, so that wind passes easily through the material, and as a result the material is relatively insensitive to wind; (ii) being pliable, i.e. foldable, due to being made from pliant net-like or net mesh material that can easily be folded or rolled up; and (iii) being appropriately heavy so that, in combination with its openness, the material will be relatively insensitive to wind conditions.

The structural properties of the material 20 can be varied as long as these properties are in place to provide material with the required openness and ground footprint weight. Thus, the openings in the material 20 can be altered in their shape and dimensions by using alternate material, alternate weaving, or both. Further, the material can have uniform openings, i.e. openings with uniform dimensions, or the material can have two or more types of openings with different shape and/or dimensions.

The airport runway is depicted by the grey background, and the marking, indicating closure of the runway, is indicated by the large X that is placed on the runway through the marking. The marking is placed over any other marking (such as runway number or code, not shown in this Figure) that may be present on the runway.

The indicium “X” can be provided in the material by painting the mesh material using the appropriate color. Alternatively, the indicium can be incorporated into the material by weaving, for example by weaving a thread having the appropriate color into the mesh material.

Obviously, the dimensions of the marking can be adapted as needed and/or as required by regulatory authorities.

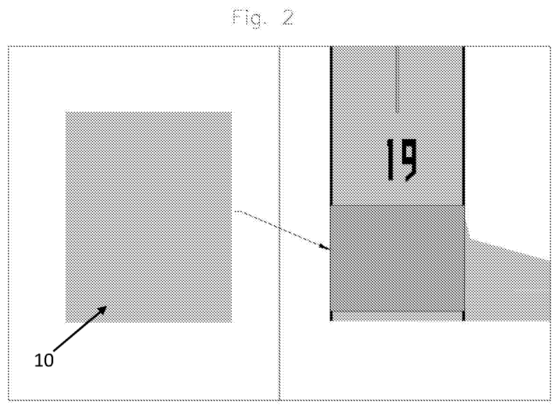

In FIG. 2, a sheet 10 of mesh material as described herein is used to cover markings on a runway. The advantage of such use is that changes in marking, or removal of marking, can be performed very quickly and reliably.

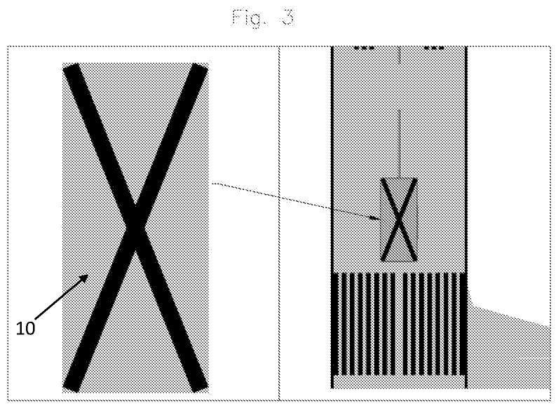

In FIG. 3 it can be seen how a rectangular sheet 10 of mesh material that includes a marking (provided by the letter X) can be used to indicate closure of a runway. The single sheet of mesh material is simply stretched onto the runway to indicate the runway closure, covering any other marking that may be on the runway.

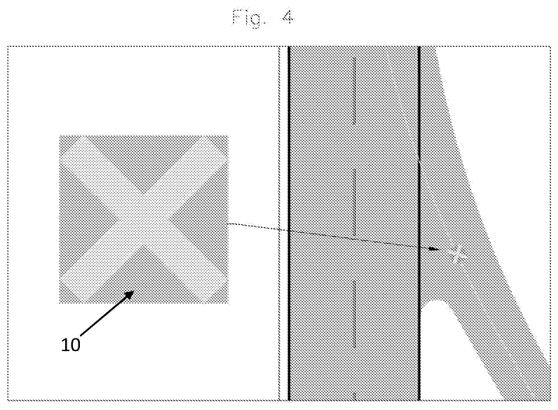

The system can also be used to provide signalling on taxiways, as indicated in FIG. 4. Here, a mesh sheet that has a cross incorporated is shown to be provided on a taxiway, indicating its closure. As in other similar embodiments, the marking on the sheet can be performed by any convenient means, such as painting, weaving a suitably colored material into the mesh, etc.

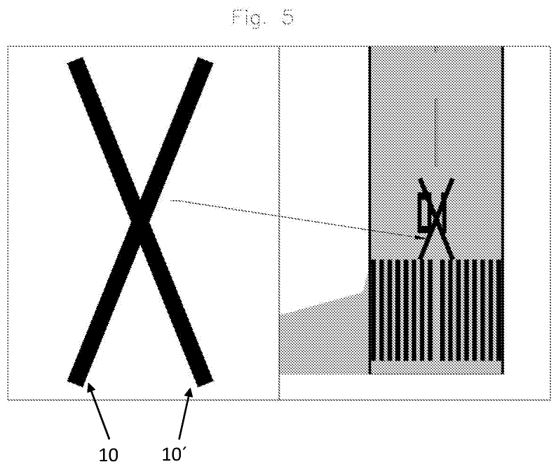

In FIG. 5, an alternate marking solution is shown. Here, the marking is provided by two elongate rectangular sheets 10,10″ of mesh material, of equal or near-equal dimensions. The two sheets cross at their respective middle portions to form the letter X, indicating closure of the runway. In the example shown, the marking is placed over an existing runway marking, which is therefore partially obscured by the marking.

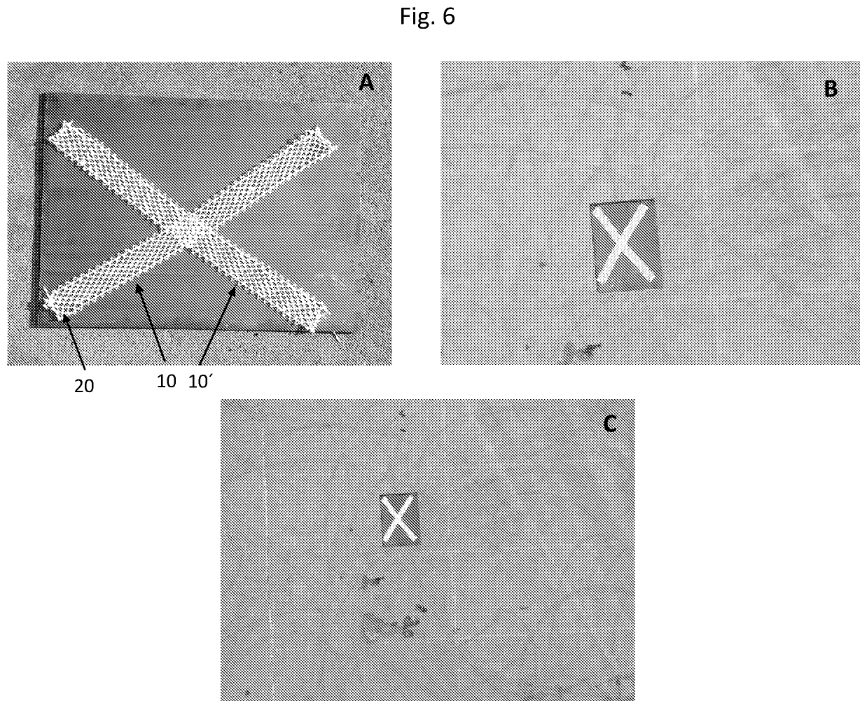

In FIG. 6, there is shown a marking system using a net-like material 20 in accordance with the invention. For illustrative purposes, the material shown has smaller dimensions than would be used in ordinary runway or taxiway markings. Thus, shown are aerial views of a net-like mesh material comprising two sheets 10,10″ forming an “X”. For illustrative purposes, a marking system place on a flat plywood board is shown. The material shown is between 70 and 80% open, has a net-like structure, where the strands in the material have a diameter of about 4 mm, and the openings in the material being diamond shaped, with an internal longitudinal length of about 4 cm and an internal traverse width of about 2.5 cm. The average internal width (the average of the longitudinal and traverse dimensions) is thus about 3.1 cm. Each strip of material in the marking shown has dimensions of approximately 15 cm×180 cm. Shown are aerial views from a height of (A) 5 m, (B), 10 m and (C) 20 m.

From a relatively close distance, i.e. an altitude of 5 m, shown in (A), the structure of the material, i.e. the net-like structure, can be seen. However, as soon as the distance is doubled, i.e. to 10 m, as shown in (B), the structure of the material is no longer visible, in that the fact that the marking is in fact provided by a net-like material, can not be seen from this distance. From a distance of 20 m, shown in (C), the solid character of the marking from a distance becomes even more apparent.

Thus, for this type of net-like material, even at short distances the material provides an appearance of a solid material when viewed from a distance. It is noted that material with substantially greater openings or pores would also appear solid from a distance of 20 m or more, which is more than sufficient for use in the context of marking on runways or taxiways, where the relevant distance from which the marking should be clearly visible is in the dozens (for taxiways) or hundreds (for runways) of meters.

This example therefore shows that net-like structures that are quite open and have large individual openings will, from a distance, have the appearance of a solid material and are therefore useful for providing markings for airway traffic.

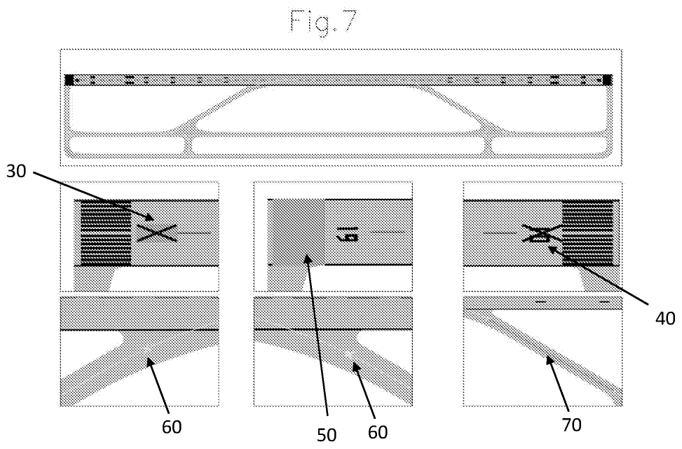

In FIG. 7, an exemplary schematic overview of an airport runway and taxiway system is shown, illustrating the various ways in which markings in accordance with the invention can be used. Thus, shown are markings 30,40 that designate runway closures in two different manners by a single sheet 30 having a built in X indicium and by two elongate sheets 40 that cross so as to form an X (leftmost and rightmost middle panels). Also shown is a sheet 50 that hides underlying marking (central middle panel), and markings 60 indicating taxiway closures (bottom panels, middle and left). Yet another possible use is indicated in the right panel, where a strip 70 of mesh material without any marking function is stretched over the central portion of a taxiway, thereby obscuring underlying markings on the taxiway.

As should be apparent to the skilled person, the marking system as disclosed herein can be modified in a number of ways so as to provide any desired marking on an airport runway or taxiway. Thereby, a distinct advantage of the system is its versatility and ease of application and transport, so that various markings within an airport can be applied quickly and reliably.

As should be apparent from the foregoing description, the present invention provides a unique solution to the problem of providing marking for air and ground transportation, in particular for airports. Advantages of the invention include:
Marking system that does not damage the surface of a runway or taxiway
Removable marking system that can be folded and/or rolled up for transport and/or storage
Marking system is insensitive to wind due a unique combination of density and mesh width
Marking system is relatively light weight and can be applied and/or removed very quickly
Markings system can be made heavier if desired using conventional means
Marking system can be stored outside
Marking system can be used in any type of inclement weather, and in both hot and cold conditions
Marking system is relatively inexpensive

Exemplary embodiments of the invention include:
1. A system for horizontal marking of air and ground transportation, the system comprising
   at least one sheet of a pliant material, the sheet comprising a mesh material that, when in use, is at least 30% open,
   wherein the at least one sheet is adapted to be disposed on an horizontal surface in a generally horizontal fashion, so as to provide a sign for conveying information to air and/or ground traffic.
2. The system of embodiment 1, wherein the at least one sheet has a ground footprint weight of at least 0.4 kg/m².
3. A system for horizontal marking of air and ground transportation, the system comprising at least one sheet of a pliant material that has a ground footprint weight of at least 0.4 kg/m², wherein the at least one sheet is adapted to be disposed on an horizontal surface in a generally horizontal fashion, so as to provide a sign for conveying information to air and/or ground traffic.
4. The system of embodiment 3, wherein the sheet comprises a mesh material that, when in use, is at least 30% open.
5. The system of any one of the preceding embodiments, wherein the mesh material is at least 40% open, preferably at least 50% open, more preferably at least 60% open, and most preferably at least 70% open.
6. The system of any one of the preceding embodiments, wherein the mesh material has a ground footprint weight of at least 0.6 kg/m², more preferably at least 0.8 kg/m², even more preferably at least 1.0 kg/m².
7. The system of any one of the preceding embodiments, wherein the mesh material has a ground footprint weight that is in the range of 0.4 to 2.0 kg/m², preferably in the range of 0.4 to 1.5 kg/m², more preferably in the range of 0.5 to 1.0 kg/m².
8. The system of any one of the preceding embodiments, wherein the system is adapted to be disposed on an horizontal surface within an airport so as to convey information to air and/or ground traffic within the airport.
9. The system of any one of the previous embodiments, characterized in that the system is adapted to be disposed on a horizontal surface without securing the resulting sheet assembly to ground.
10. The system of any one of the previous embodiments, the system comprising a sheet assembly of two or more rectangular sheets of pliant mesh material that are assembled so that one sheet at least partially overlaps another sheet and wherein the sheet assembly of two or more sheets so provided provides a sign for conveying air/and or ground traffic information.
11. The system of any one of the previous embodiments, the system comprising an sheet assembly of two elongate rectangular sheets of pliant mesh material that are adapted to be assembled on a horizontal surface so that one sheet is stretched in a first direction on the horizontal surface so as to provide a first arm, and a second sheet is stretched in a second direction on the horizontal surface to provide a second arm, wherein the two arms so provided cross to provide a sign for conveying air/and or ground traffic information.
12. The system of any one of the previous embodiments 1 to 10, the system comprising a single sheet of pliant mesh material, wherein the pliant sheet has provided therein at least one indicium, so that when stretched on a horizontal surface, the at least one indicium provides a sign for conveying information to air and/or ground traffic.
13. The system of the previous embodiment, wherein the indicium is threaded in the mesh structure.
14. The system of the previous two embodiments 12 or 13, wherein the indicium is provided by colouring patterns in the mesh material.
15. The system of any one of the previous embodiments, wherein the mesh material comprises a net-like structure having an average mesh width that is in the range of about 5 to 100 mm, preferably in the range of about 10 to 80 mm, more preferably in the range of about 10 to 60 mm, more preferably in the range of about 10 to 50 mm, even more preferably in the range of about 15 to 35 mm.
16. The system of any one of the preceding embodiments, wherein the mesh material comprises a net-like structure having a uniform structure.
17. The system of any one of the preceding embodiments, wherein the mesh material comprises synthetic fibre material selected from the group consisting of polyamide (such as Nylon, Perlon), polyester (such as Terylene, Dacron, Tetoron, Trevira), polyethylene (such as Nymplex, Courlene), polypropylene (such as Danaflex, Multiflex, Ulstron), aramid (such as Kevlar), high-density polyethylene (such Dyneema, Spektra, Dynex).
18. The system of any one of the preceding embodiments, wherein the pliant mesh material can be folded and/or rolled up for storage, such that its ground footprint during storage is less than 1% of its ground footprint during use.
19. The system of any one of the preceding embodiments, wherein the at least one sheet, when in use, is stable to horizontal perturbations by wind of at least 20 m/s.
20. A method of directing air or ground traffic, the method comprising steps of:
   providing at least one sheet of a pliant material, the sheet comprising a mesh material that is at least 30% open
   positioning the at least one sheet on an horizontal surface in a generally horizontal fashion, so that the at least one sheet as positioned provides a sign for conveying information to air and/or ground traffic that can be detected from a distance,
   whereby air or ground traffic that approaches the sign is directed to adapt their direction of travel in response to the sign.
21. The method of embodiment 20, wherein the at least one sheet is stretched onto the horizontal surface so as to provide a sign for conveying information.
22. The method of embodiment 20, wherein the at least one sheet is extended on the horizontal surface so that the sheet forms a single layer on the surface.
23. The method of embodiment 20 or embodiment 21 or embodiment 22, wherein the at least one sheet has a ground footprint weight of at least 0.4 kg/m².
24. The method of any one of the embodiments 20 to 23, wherein the horizontal surface is an airport runway, an airport taxiway or an airport roadway.
25. The method of any one of the embodiments 20 to 24, wherein the method is carried using a system is as set forth in any one of the embodiments 1-19.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

It will be appreciated that variations to the foregoing embodiments of the invention can be made while still falling within the scope of the invention can be made while still falling within scope of the invention. Features disclosed in the specification, unless stated otherwise, can be replaced by alternative features serving the same, equivalent or similar purpose. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

1. A system for horizontal marking of air and ground transportation, the system comprising
at least one sheet of a pliant material, the sheet comprising a mesh material that, when in use, is at least 30% open,
wherein the at least one sheet is adapted to be disposed on an horizontal surface in a generally horizontal fashion, so as to provide a sign for conveying information to air and/or ground traffic.

2. The system of claim 1, wherein the at least one sheet has a ground footprint weight of at least 0.4 kg/m².

3. A system for horizontal marking of air and ground transportation, the system comprising
at least one sheet of a pliant material that has a ground footprint weight of at least 0.4 kg/m², wherein the at least one sheet is adapted to be disposed on an horizontal surface in a generally horizontal fashion, so as to provide a sign for conveying information to air and/or ground traffic.

4. The system of claim 3, wherein the sheet comprises a mesh material that, when in use, is at least 30% open.

5. The system of claim 1, wherein the mesh material is at least 40% open, preferably at least 50% open, more preferably at least 60% open, and most preferably at least 70% open.

6. The system of claim 1, wherein the mesh material has a ground footprint weight of at least 0.6 kg/m², more preferably at least 0.8 kg/m², even more preferably at least 1.0 kg/m².

7. The system of claim 1, wherein the mesh material has a ground footprint weight that is in the range of 0.4 to 2.0 kg/m², preferably in the range of 0.4 to 1.5 kg/m², more preferably in the range of 0.5 to 1.0 kg/m².

8. The system of claim 1, wherein the system is adapted to be disposed on an horizontal surface within an airport so as to convey information to air and/or ground traffic within the airport.

9. The system of claim 1, wherein the system is adapted to be disposed on a horizontal surface without securing the resulting sheet assembly to ground.

10. The system of claim 1, the system comprising a sheet assembly of two or more rectangular sheets of pliant mesh material that are assembled so that one sheet at least partially overlaps another sheet and wherein the sheet assembly of two or more sheets so provided provides a sign for conveying air/and or ground traffic information.

11. The system of claim 1, the system comprising a sheet assembly of two elongate rectangular sheets of pliant mesh material that are adapted to be assembled on a horizontal surface so that one sheet is stretched in a first direction on the horizontal surface so as to provide a first arm, and a second sheet is stretched in a second direction on the horizontal surface to provide a second arm, wherein the two arms so provided cross to provide a sign for conveying air/and or ground traffic information.

12. The system of claim 1, the system comprising a single sheet of pliant mesh material, wherein the pliant sheet has provided therein at least one indicium, so that when stretched on a horizontal surface, the at least one indicium provides a sign for conveying information to air and/or ground traffic.

13. The system of claim 12, wherein the indicium is threaded in the mesh material.

14. The system of claim 12, wherein the indicium is provided by colouring patterns in the mesh material.

15. The system of claim 1, wherein the mesh material comprises a net-like structure having an average mesh width that is in the range of about 5 to 100 mm, preferably in the range of about 10 to 80 mm, more preferably in the range of about 10 to 60 mm, more preferably in the range of about 10 to 50 mm, even more preferably in the range of about 15 to 35 mm.

16. The system of claim 1, wherein the mesh material comprises a net-like structure having a uniform structure.

17. The system of claim 1, wherein the mesh material comprises synthetic fibre material selected from the group consisting of polyamide (such as Nylon, Perlon), polyester (such as Terylene, Dacron, Tetoron, Trevira), polyethylene (such as Nymplex, Courlene), polypropylene (such as Danaflex, Multiflex, Ulstron), aramid (such as Kevlar), high-density polyethylene (such Dyneema, Spektra, Dynex).

18. The system of claim 1, wherein the pliant mesh material can be folded and/or rolled up for storage, such that its ground footprint during storage is less than 1% of its ground footprint during use.

19. The system of claim 1, wherein the at least one sheet, when in use, is stable to horizontal perturbations by wind of at least 20 m/s.

20. A method of directing air or ground traffic, the method comprising steps of:
providing at least one sheet of a pliant material, the sheet comprising a mesh material that, during use, is at least 30% open
positioning the at least one sheet on an horizontal surface in a generally horizontal fashion, so that the at least one sheet as positioned provides a sign for conveying information to air and/or ground traffic that can be detected from a distance,
whereby air or ground traffic that approaches the sign is directed to adapt their direction of travel in response to the sign.

21. The method of claim 20, wherein the at least one sheet is extended on the horizontal surface so as to provide a sign for conveying information.

22. The method of claim 20, wherein the at least one sheet has a ground footprint weight of at least 0.4 kg/m².

23. The method of claim 20, wherein the horizontal surface is an airport runway, an airport taxiway or an airport roadway.

24. The method of claim 20, wherein the method is carried using a system for horizontal marking of air and ground transportation, the system comprising
at least one sheet of a pliant material, the sheet comprising a mesh material that, when in use, is at least 30% open,
wherein the at least one sheet is adapted to be disposed on an horizontal surface in a generally horizontal fashion, so as to provide a sign for conveying information to air and/or ground traffic.
